(19) United States
(12) Patent Application Publication
(10) Pub. No.: US 2025/0216518 A1
(43) Pub. Date: Jul. 3, 2025

(54) CONTROL CIRCUIT, SYSTEM, METHOD, AND PROGRAM

(71) Applicant: Sony Interactive Entertainment Inc., Tokyo (JP)

(72) Inventor: Takashi SHIMAZU, Tokyo (JP)

(73) Assignee: Sony Interactive Entertainment Inc., Tokyo (JP)

(21) Appl. No.: 18/848,137

(22) PCT Filed: Mar. 31, 2022
(86) PCT No.: PCT/JP2022/016481

§ 371 Date: Sep. 18, 2024

(51) Int. Cl. G01S 7/4865; G01S 7/4861; H04N 25/47

(52) U.S. Cl. CPC G01S 7/4865; G01S 7/4861; H04N 25/47

(57) ABSTRACT

Provided is a control circuit of a dToF sensor. The control circuit includes a memory for storing a program code, and a processor for executing operation in accordance with the program code. The operation includes counting the number of events detected in a measurement possible region of the dToF sensor by an event-based vision sensor, and determining a measurement target region of the dToF sensor in the measurement possible region according to count of events.

### TECHNICAL FIELD

The present invention relates to a control circuit, a system, a method, and a program.

### BACKGROUND ART

A ToF (Time of Flight) sensor which measures a distance to an object on the basis of a time of flight of light, has been used to obtain three-dimensional information regarding a subject, for example. ToF sensors are broadly categorized into dToF (direct ToF) for measuring a time difference between emission of application light and reception of its reflection light, and iToF (indirect ToF) for measuring a distance by storing reflection light and detecting a phase difference between the reflection light and emitted light. A technology concerning a ToF sensor is described in PTL1, for example.

### CITATION LIST

### Patent Literature

[PTL 1]
Japanese Patent Laid-Open No. 2019-078748

### SUMMARY

### Technical Problem

In the above-mentioned ToF sensor, a light collecting area in each pixel needs to be increased to some extent, and thus, there has been a limitation to reduction of the pixel interval. Therefore, it is not easy to simultaneously obtain a large measurement region and a high spatial resolution in a ToF sensor. When a proper region of interest (ROI) is determined for measurement, it is sufficient to conduct measurement only in this region with a high spatial resolution, for example, so that the spatial resolution of the ToF sensor is substantially increased. However, a technology of determining a proper region of interest with low latency, has not been proposed.

Accordingly, an object of the present invention is to provide a control circuit, a system, a method, and a program for determining a proper measurement target region of a ToF sensor with low latency.

### Solution to Problem

According to a certain aspect of the present invention, provided is a control circuit of a dToF sensor. The control circuit includes a memory for storing a program code, and a processor for executing operation in accordance with the program code. The operation includes counting the number of events detected in a measurement possible region of the dToF sensor by an event-based vision sensor, and determining a measurement target region in the measurement possible region of the dToF sensor according to count of events.

According to another aspect of the present invention, provided is a method of controlling a dToF sensor. The method includes, through operation that is executed by a processor in accordance with a program code stored in a memory, counting the number of events detected in a measurement possible region of the dToF sensor by an event-based vision sensor, and determining a measurement target region of the dToF sensor in the measurement possible region according to count of events.

According to still another aspect of the present invention, provided is a program for controlling a dToF sensor. In the program, operation that is executed by a processor in accordance with the program includes counting the number of events detected in a measurement possible region of the dToF sensor by an event-based vision sensor, and determining a measurement target region of the dToF sensor in the measurement possible region according to the number of the events.

According to yet another aspect of the present invention, provided is a system including a dToF sensor. The system includes at least one device including a memory for storing a program code, and a processor for executing operation in accordance with the program code. The operation includes counting the number of events detected in a measurement possible region of the dToF sensor by an event-based vision sensor, and determining a measurement target region of the dToF sensor in the measurement possible region according to the number of the events.

### BRIEF DESCRIPTION OF DRAWINGS

FIG. 1 is a diagram depicting an example of a dToF sensor including a control circuit according to one embodiment of the present invention.

FIG. 2 is a conceptual diagram depicting operation that is executed in the dToF sensor depicted in FIG. 1.

FIG. 3 is a flowchart of an example of operation that is executed in the one embodiment of the present invention.

### DESCRIPTION OF EMBODIMENT

Hereinafter, an embodiment of the present invention will be explained in detail with reference to the drawings. It is to be noted that components having substantially the same functional structure are denoted by the same reference numeral throughout the present description and the drawings, and a redundant explanation thereof will be omitted.

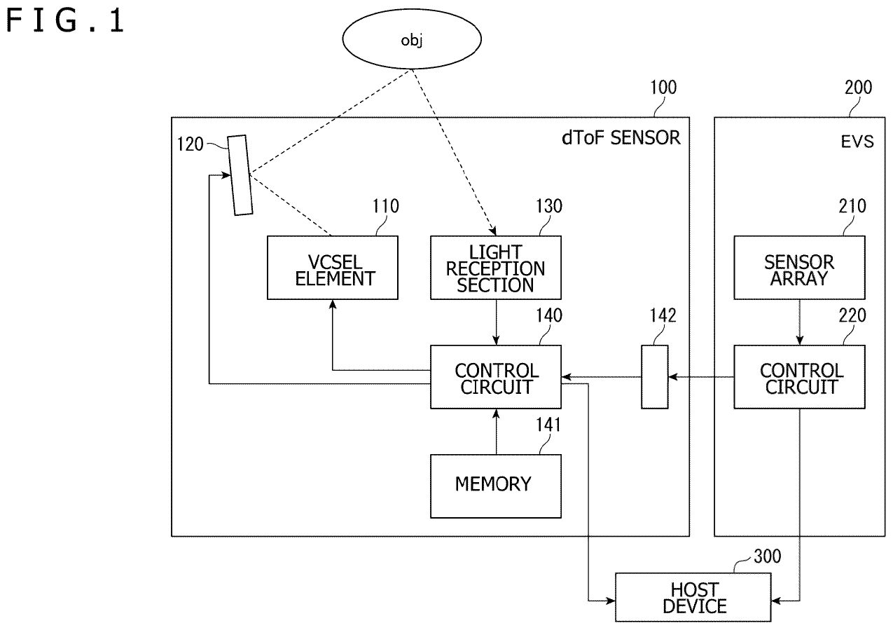

FIG. 1 is a diagram depicting an example of a dToF sensor including a control circuit according to one embodiment of the present invention. In the depicted example, a dToF (direct Time of Flight) sensor 100 includes a VCSEL (Vertical Cavity Surface Emitting Laser) element 110 which is a light source, a mirror 120 that controls a direction of laser light emitted from the VCSEL element 110, a light reception section 130 that receives reflection light of the laser light reflected by an object in a space, and a control circuit 140. In the dToF sensor 100, laser light emitted by the VCSEL element 110 is applied to an object obj through the mirror 120, and its reflection light is received by the light reception section 130. A time difference between application of the laser bean and reception of the reflection light is measured, whereby the distance to the object obj can be measured. The control circuit 140 can control an application range of laser light by moving or rotating the VCSEL element 110 and/or the mirror 120 by means of an actuator or the like. A region where laser light is applied under such control, and the distance to the object obj in the region is measured, is also referred to as a measurement target region of the dToF sensor 100 herein.

In the present embodiment, an event-based vision sensor (EVS) 200 is connected to the dToF sensor 100. The EVS 200 is also called an EDS (Event Driven Sensor), an event camera, or a DVS (Dynamic Vision Sensor). The EVS 200 includes a sensor array 210 formed of sensors provided with light reception elements, and a control circuit 220. In the EVS 200, when a sensor detects a change in the intensity of incident light, or more specifically, a change in the brightness on a surface of an object, an event signal including a time stamp, identification information on the sensor, and information regarding the polarity of the brightness change is generated. The control circuit 220 of the EVS 200 transmits the generated event signal to the control circuit 140 of the dToF sensor 100. In addition, the control circuit 220 may transmit the event signal to a host device 300 such that the event signal is used for any other purpose. The host device 300 is a game machine, a personal computer (PC), or a server device connected over a network, for example. Output from the light reception section 130 of the dToF sensor 100 also may be transmitted to the host device 300 via the control circuit 140. It is to be noted that outputs from the EVS 200 and the dToF sensor 100 are not necessarily transmitted to the same host device 300.

The control circuit 140 of the dToF sensor 100 is formed of a processing circuit such as a DSP (Digital Signal Processor), an ASIC (Application Specific Integrated Circuit), and/or an FPGA (Field-Programmable Gate Array). A memory 141 that is formed of any ROM (Read Only Memory) and/or any RAM (Random Access Memory), for example, is connected to the control circuit 140. By operating in accordance with a program code stored in the memory 141, the control circuit 140 executes operation which will be explained later. Further, a communication interface 142 for receiving an event signal from the EVS 200 is connected to the control circuit 140. The control circuit 220 of the EVS 200 is also formed of a processing circuit similar to the control circuit 140 of the dToF sensor 100. A memory (not depicted) is connected to the control circuit 220. An event signal that the control circuit 220 of the EVS 200 transmits to the control circuit 140 of the dToF sensor 100 via the communication interface 142, is an example of information indicating the number of the events detected in a measurement possible region of the dToF sensor 100 by the EVS 200.

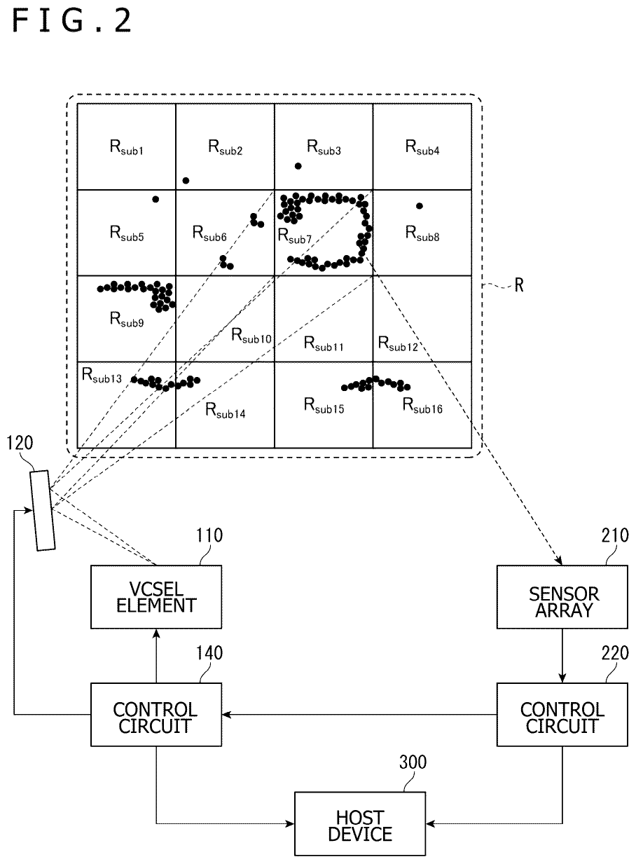

FIG. 2 is a conceptual diagram depicting operation that is executed by the dToF sensor depicted in FIG. 1. In the dToF sensor 100, the control circuit 140 controls a direction to which the VCSEL element 110 applies laser light, and/or a direction to which the laser light is reflected at the mirror 120. Accordingly, a measurement target region can be moved within a measurement possible region R. It is to be noted that the VCSEL element 110 and/or the mirror 120 may be operable in either one of a mode of applying low-density laser light to the entire measurement possible region R and a mode of applying high-density laser light to a portion of the measurement possible region R. In this case, the difference of the measurement target region is executed in the mode of applying high-density laser light to a portion of the measurement possible region R.

The sensor array 210 of the EVS 200 detects an event that is a brightness change generated in the measurement possible region R of the dToF sensor 100. An event signal that is generated when the sensor array 210 detects an event, includes sensor identification information, as previously explained, and is inputted to the control circuit 140 of the dToF sensor 100 via the control circuit 220 of the EVS 200. The control circuit 140 can identify a position where the event is detected in the measurement possible region R, from the sensor identification information. More specifically, the control circuit 140 can identify in which one of sub-regions R_{sub1} to R_{sub16} an even is detected. The sub-regions R_{sub1} to R_{sub16} are obtained by dividing the measurement possible region R. The control circuit 140 counts events detected in the measurement possible region R by the EVS 200, and determines a measurement target region of the dToF sensor 100 in the measurement possible region R. More specifically, the control circuit 140 counts events detected in each of the sub-regions R_{sub1} to R_{sub16} in a prescribed time window, and determines, as a measurement target region, a sub-region where the number of the events detected is relatively large.

In one method of determining a measurement target region, the control circuit 140 may determine, as a measurement target region, one sub-region where the number of the events is the largest. Alternatively, the control circuit 140 may sequentially determine, as a measurement target region, a plurality of sub-regions where the number of the events is relatively large. In the depicted example, the number of the events detected in the sub-region R_{sub7} is the largest, and the number of the events detected in the sub-region R_{sub9} is the second largest. In this case, the control circuit 140 may determine only the sub-region R_{sub7} as a measurement target region, or may first determine the sub-region R_{sub7} as a measurement target region, and then, determine the sub-region R_{sub9} as a measurement target region.

In one method for determining a measurement target region without using sub-regions, the control circuit 140 may identify a position where the density of positions of detected events is the highest in the measurement possible region R, and determine a region around the identified position as a measurement target region. In one method for determining a measurement target region without using a prescribed time window, the control circuit 140 may continue counting the number of events only when events are consecutively detected at an interval shorter than a prescribed time interval, and may reset the count at the prescribed time interval otherwise.

In a case where the number of the events detected by the EVS 200 in the prescribed time window is low, or in a case where, for example, the counts of events in the respective sub-regions are all less than the threshold, or the number of the events detected in the measurement possible region R is less than the threshold, the control circuit 140 can refrain from determining a measurement target region. In this case, the dToF sensor 100 may conduct measurement in the entire measurement possible region R with a reduced spatial resolution, or may sequentially conduct measurement in the sub-regions R_{sub1} to R_{sub16} in order that is defined separately from the measurement target region determining procedure, or may continue measurement in a measurement target region determined in the previous time window. Alternatively, in this case, the dToF sensor 100 may halt measurement. While the dToF sensor 100 halts measurement, the control circuit 140 continuously counts events detected by the EVS 200. If the number of the events becomes greater than the threshold, the dToF sensor 100 resumes the measurement.

The control circuit 140 sets the direction of the VCSEL element 110 and/or the mirror 120 toward the determined measurement target region such that laser light is applied to the measurement target region. The control circuit 140 measures a time difference to reception of reflection light at the light reception section 130 such that distance measurement is conducted. Accordingly, even in a case where there is a limitation to reduction of a pixel interval in the light reception section 130, for example, a measurement target region can be limited, so that measurement is conducted with a high spatial resolution.

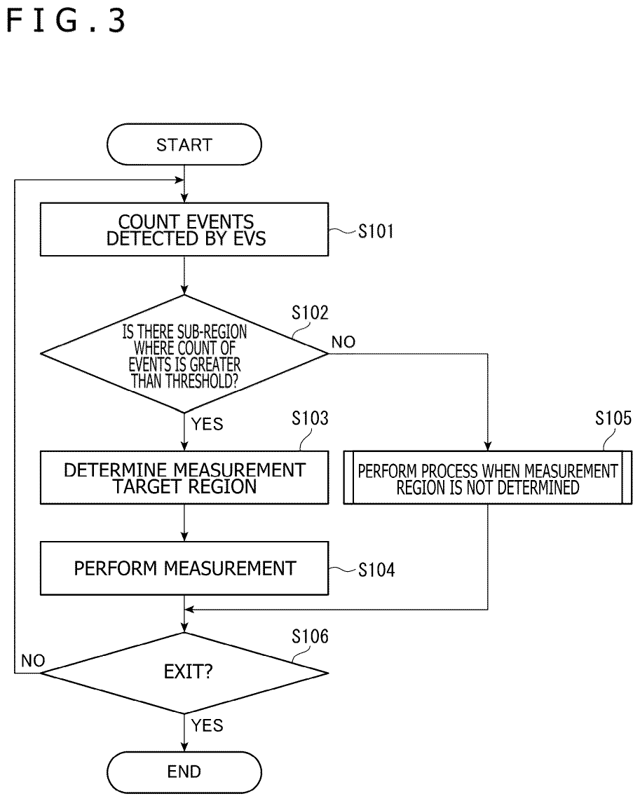

FIG. 3 is a flowchart of an example of operation that is executed in one embodiment of the present invention. The control circuit 140 of the dToF sensor 100 counts, in each of the sub-regions R_{sub1} to R_{sub16}, events detected in the measurement possible region R by the EVS 200 (step S101), and determines whether or not there is a sub-region where the number of the events in a prescribed time window is greater than a threshold (step S102). In a case where there is a sub-region where the number of the events is greater than the threshold, the control circuit 140 determines, as a measurement target region, the sub-region where the number of the events is greater than the threshold (step S103), and conducts measurement in the measurement target region by controlling the mirror 120 and/or the VCSEL element 110 which is a light source (step S104). In a case where there are two or more sub-regions where the number of the events is greater than the threshold, steps S103 and S104 may be executed only for the sub-region where the number of the events is the largest, or steps S103 and S104 may be repeated for the sub-regions where the number of the events is greater than the threshold, in order from a sub-region where the number of the events is the largest. In this case, the count of sub-regions to be subjected to steps S103 and S104 may be restricted in view of the relationship between the length of the prescribed time window and a required measurement time.

In a case where there is no sub-region where the number of the events is greater than the threshold at step S102, the control circuit 140 executes the process for a case where a determination of a measurement target region is refrained (step S105). In this case, the dToF sensor 100 may conduct measurement in the entire measurement possible region R with a reduced spatial resolution, or may sequentially conduct measurement in the sub-regions Rsub1 to Rsub16 in order that is defined separately from the measurement target region determining procedure, or may continue measurement in a measurement target region determined in the previous time window, for example, as previously explained.

Steps S101 to S105 are repeated until measurement by the dToF sensor 100 is completed (step S106). It is to be noted that the number of the events in each of the sub-regions R_{sub1} to R_{sub16} is reset for every time window, for example. More specifically, the number of the events is reset when determination of a measurement target region (step S102) is started, and counting the number of events in the next time window (step S101) may be performed in parallel with the following steps S102 to S105.

According to the above-mentioned embodiment of the present invention, the control circuit 140 of the dToF sensor 100 determines a measurement target region according to the number of the events detected by the EVS 200. Since the EVS 200 has a high time resolution and a high spatial resolution, the EVS 200 can precisely and quickly identify a region where an object moves, from the number of the events, and properly determine a measurement target region of the dToF sensor 100. In addition, the control circuit 140 of the dToF sensor 100 executes the above-mentioned process according to an event signal inputted from the EVS 200, without requiring intervention of, for example, a host device. Accordingly, a measurement target region can be determined with low latency.

The embodiment of the present invention has been explained above in detail with reference to the drawings. However, the present invention is not limited to the embodiment. It is clear that a person who has the common knowledge in the technical field of the present invention can conceive of various modifications and revisions within the scope of the technical concept set forth in the claims. These modifications and revisions are also considered to obviously fall within the technical scope of the present invention.

### REFERENCE SIGNS LIST

100: dToF sensor
110: VCSEL element
120: Mirror
130: Light reception section
140: Control circuit
141: Memory
142: Communication interface
200: EVS
210: Sensor array
220: Processing circuit
300: Host device

1. A control circuit of a dToF sensor, comprising:
a memory for storing a program code; and
a processor for executing operation in accordance with the program code, wherein the operation includes
counting the number of events detected in a measurement possible region of the dToF sensor by an event-based vision sensor, and
determining a measurement target region of the dToF sensor in the measurement possible region according to the number of the events.

2. The control circuit according to claim 1, wherein
the events are counted in each of multiple regions into which the measurement possible region is divided in a prescribed time window, and
a region where the number of the events is relatively large among the multiple regions is determined as the measurement target region.

3. The control circuit according to claim 2, wherein
the region where the number of the events is relatively large includes a first region, and a second region where the number of the events is less than that in the first region, and
the first region and the second region are determined in this order as the measurement region.

4. The control circuit according to claim 1, wherein
the operation further includes setting at least any one of a light source or a mirror included in the dToF sensor, toward the measurement target region.

5. The control circuit according to claim 1, wherein,
in a case where the number of the events is less than a threshold, determination of the measurement target region is refrained.

6. A system including a dToF sensor, the system comprising:
at least one device including a memory for storing a program code, and a processor for executing operation in accordance with the program code,
the operation including
counting the number of events detected in a measurement possible region of the dToF sensor by an event-based vision sensor, and
determining a measurement target region of the dToF sensor in the measurement possible region according to the number of the events.

7. The system according to claim 6, further comprising:
the dToF sensor; and
the event-based vision sensor, wherein
the processor is included in a control circuit of the dToF sensor, and
a control circuit of the vision sensor transmits at least information indicating the number of the events to the control circuit of the dToF sensor via a communication interface between the vision sensor and the dToF sensor.

8. A method of controlling a dToF sensor, through operation that is executed by a processor in accordance with a program code stored in a memory, the method comprising:
counting the number of events detected in a measurement possible region of the dToF sensor by an event-based vision sensor; and
determining a measurement target region of the dToF sensor in the measurement possible region according to the number of the events.

9. A program for controlling a dToF sensor, through operation that is executed by a processor in accordance with the program, the program comprising:
counting the number of events detected in a measurement possible region of the dToF sensor by an event-based vision sensor; and
determining a measurement target region of the dToF sensor in the measurement possible region according to the number of the events.
